(19) United States
(12) Patent Application Publication
(10) Pub. No.: US 2004/0215867 A1
(43) Pub. Date: Oct. 28, 2004

(54) Control chip, circuit and method thereof for inhibiting bus cycle

(76) Inventor: Hung-Yi Kuo, Hsin-Tien City (TW)

Correspondence Address: J.C. Patents, Inc., Suite 250, 4 Venture, Irvine, CA, 92618, US

(21) Appl. No.: 10/697,773

(22) Filed: Oct. 29, 2003

(30) Foreign Application Priority Data
Apr. 28, 2003 (TW) 92109868

(51) Int. Cl. G06F 13/36

(52) U.S. Cl. 710/306

(57) ABSTRACT

A control chip, a circuit and a method thereof with bus cycle inhibiting function is provided. A bus resource decode circuit is used to determine if a bus cycle picked up from a first bus is an internal bus cycle type of the control chip. If the bus cycle is found to be an internal bus cycle, an inhibit signal is transmitted to a bus bridging circuit after a logic computation inside a logic circuit so that a re-transmission of the internal bus cycle to a second bus is inhibited. In this manner, the second bus may step into an idle state and save some electrical power.

### CROSS-REFERENCE TO RELATED APPLICATION

This application claims the priority benefit of Taiwan application serial no. 92109868, filed on Apr. 28, 2003.

### BACKGROUND OF THE INVENTION

1. Field of Invention

The present invention relates to a control chip. More particularly, the present invention relates to a control chip, circuit and method thereof for inhibiting a bus cycle.

2. Description of Related Art

Aside from serving as a central control unit, the main board or motherboard inside a personal computer also integrates with a set of control chips for controlling the various interface cards and peripheral computer devices attached to the computer.

In general, communication between the interface cards and the peripheral computer devices are controlled through a chipset that includes a so-called North-bridge and a South-bridge control chips. The North-bridge control chip is coupled to a central processing unit for receiving and responding to instructions transmitted from the central processing unit. The South-bridge control chip is coupled to the bus of the North-bridge control chip for receiving bus cycles from the North-bridge control chip, and converting the bus cycles through a bridging circuit inside the South-bridge control chip into various bus cycles for the various attached interface cards and computer peripheral devices. The most common bus used today for accepting the plug-in interface cards is the so-called peripheral component interconnect (PCI) bus.

FIG. 1 is a block diagram showing the internal and associated components of a conventional South-bridge control chip. As shown in FIG. 1, the South-bridge control chip 100 is coupled to a North-bridge control chip (not shown) via an inter-chip bus 101 so that the South-bridge control chip 100 is able to receive bus cycles from the North-bridge control chip. Upon receiving the bus cycles, the South-bridge control chip distributes the bus cycles to a low pin count (LPC) bridging circuit 140, an XA bridging circuit 150, a PCI bridging circuit 160 and some other bridging circuit 170. Hence, instruction and data communication via an LPC bus 102, an XA bus 103, a PCI bus 104 and some other types of buses (for example, USB bus) 105 are all supported. However, unless the target of the bus cycle is the second cycle target 120 connected to the LPC bus 102 or the third cycle target 130 connected to the XA bus 103, the bus cycle received is continuously checked to determine if the bus cycle is reserved for the PCI bus 104. Moreover, if the received bus cycle is an internal bus cycle for the first cycle target 110 inside the South-bridge control chip 100, the internal bus cycle will be transmitted to the PCI bus 104 and other bridging circuit 170 anyway. Hence, the setup inside a conventional South-bridge control chip often leads to a waste of cycle time and electrical power.

### SUMMARY OF THE INVENTION

Accordingly, one object of the present invention is to provide a control chip, circuit and method thereof for inhibiting bus cycle. Whenever a first bus of the control chip receives an internal bus cycle, the bus cycle is inhibited from transmitting further to a second bus so that the second bus may step into an idle state and save some electrical power.

To achieve these and other advantages and in accordance with the purpose of the invention, as embodied and broadly described herein, the invention provides a bus cycle inhibiting circuit and a control chip having this type of bus cycle inhibiting function and control. The control chip is capable of receiving an internal bus cycle type of the control chip from a first bus, and inhibiting the transmission of such bus cycle to a second bus.

Aside from the aforementioned bus cycle inhibiting circuit, the control chip furthermore comprises a bus bridging circuit. The bus cycle inhibiting circuit receives a bus cycle from a first bus and determines whether or not the bus cycle belongs to an internal bus cycle type of the control chip. If the bus cycle is an internal bus cycle type of the control chip, an inhibiting signal is issued. The bus bridging circuit is coupled to the bus cycle inhibiting circuit. According to the inhibiting signal from the bus cycle inhibiting circuit, the bus bridging circuit inhibits further transmission of the bus cycle.

The bus cycle inhibiting circuit further comprises a bus resource decode circuit and a logic circuit. The bus resource decode circuit receives a bus cycle from the first bus and outputs an indicator signal representing the type of bus cycle, when the bus cycle is found to be an internal bus cycle type of the control chip. According to a preset enable value and the indicator signal from the bus resource decode circuit, the logic circuit outputs an inhibiting signal.

In one embodiment of this invention, the bus resource decode circuit furthermore comprises an input/output (I/O) resource decode unit, a memory resource decode unit and a configuration resource decode unit. The I/O resource decode unit receives a bus cycle from the first bus and outputs an indicator signal representing an internal I/O bus cycle when the bus cycle is determined to be an internal I/O bus cycle type of the control chip. The memory resource decode unit receives a bus cycle from the first bus and outputs an indicator signal representing an internal memory bus cycle when the bus cycle is determined to be an internal memory bus cycle type of the control chip. The configuration resource decode unit receives a bus cycle from the first bus and outputs an indicator signal representing an internal configuration bus cycle when the bus cycle is determined to be an internal configuration bus cycle type of the control chip.

In one embodiment of this invention, a register is used to store up the preset enable value and a logic circuit comprising of AND gates and OR gates is used to determine if the inhibiting function of the various internal bus cycles are enabled.

In one embodiment of this invention, the control chip is a South-bridge control chip and the second bus is the peripheral component interconnect (PCI) bus of the South-bridge control chip.

This invention also provides a method of inhibiting bus cycle in a control chip having at least a first bus and a second bus. The bus cycle inhibiting method includes the following steps. First, the first bus picks up a bus cycle and then the bus cycle is checked to determine if it is an internal bus cycle type of the control chip. If the bus cycle is an internal bus cycle type of the control chip, an inhibiting signal is output. According to the actual state of the inhibiting signal, further transmission of the bus cycle to the second bus is inhibited.

When the bus cycle is determined to be the internal I/O bus cycle type of the control chip, the internal memory bus cycle type of the control chip or the internal configuration bus cycle type of the control chip, the aforementioned inhibiting signal is output.

Furthermore, the aforementioned inhibiting signal is output after referencing a preset enable value.

In addition, the control chip can be a South-bridge control chip so that the second bus is the PCI bus of the South-bridge control chip.

In brief, this invention provides a control chip, a circuit and method thereof having bus cycle inhibiting function. Since any internal bus cycle type of the control chip picked up by the first bus is inhibited, such internal bus cycle is no longer transmitted to the second bus. Hence, the second bus may step into an idle state to reduce power consumption.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the internal and associated components of a conventional South-bridge control chip.

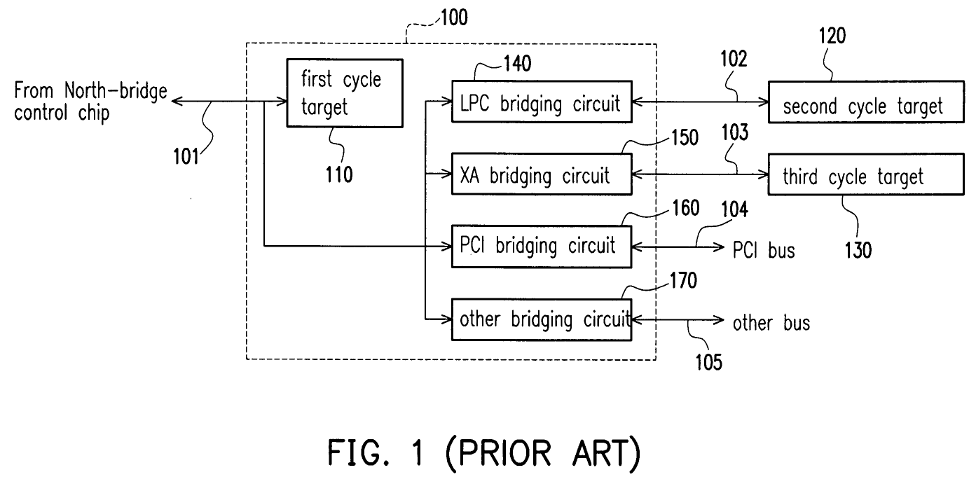

FIG. 2 is a block diagram showing the internal components of a control chip according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In a conventional South-bridge control chip, internal bus cycles of the control chip will still be transmitted to the PCI bus so that some unnecessary processing time and electrical power are wasted, as mentioned previously. For a mobile device that relies on battery power, such as a notebook computer, this is a major drawback. To conserve electric power, this invention provides a control chip, circuit and method thereof that can selectively inhibit bus cycles.

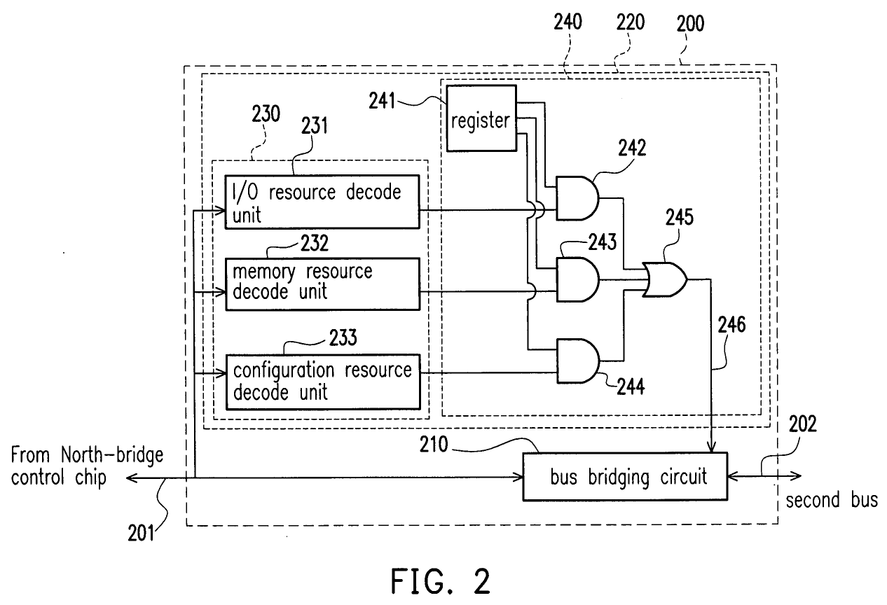

FIG. 2 is a block diagram showing the internal components of a control chip according to one preferred embodiment of this invention. As shown in FIG. 2, a control chip 200 such as a South-bridge control chip is provided. The control chip 200 receives bus cycles from a first bus 201 coupled to a North-bridge control chip (not shown). Through a conversion of the bus cycles inside a bus bridging circuit 210, instructions and data can be transmitted via a second bus 202 that supports a PCI bus, for example. Aside from the bus bridging circuit 210, the control chip 200 furthermore comprises a bus cycle inhibiting circuit 220. The bus cycle inhibiting circuit 220 comprises a bus resource decode circuit 230 and a logic circuit 240. The bus resource decode circuit 230 includes an input/output resource decode unit 231, a memory resource decode unit 232 and a configuration resource decode unit 233. The logic circuit 240 includes a register 241, AND gates 242, 243, 244 and an OR gate 245.

The bus bridging circuit 210 receives bus cycles from a North-bridge control chip (not shown) via the first bus 201 and converts the bus cycles into second bus cycles for a PCI bus before sending to the second bus 202. Obviously, to save electric power, the bus bridging circuit 210 must not receive all bus cycles unconditionally and covert the bus cycles into the second bus cycles regardless. Rather, the bridging circuit 210 must select bus cycles according to an inhibiting signal 246 from the bus cycle inhibiting circuit 220 so that bus cycles belonging to the control chip 200 or internal bus cycles are inhibited.

The bus resource decode circuit 230 comprising the input/output resource decode unit 231, the memory resource decode unit 232 and the configuration resource decode unit 233 receives bus cycles from the North-bridge control chip (not shown). The bus resource decode circuit 230 is a device for determining whether a bus cycle is an internal I/O bus cycle, an internal memory bus cycle or an internal configuration bus cycle type of the control chip. When the bus cycle is an internal I/O bus cycle, an internal memory bus cycle or an internal configuration bus cycle, a corresponding indicator signal of the internal I/O bus cycle, the internal memory bus cycle or the internal configuration bus cycle is output.

The register 241 is a storage device for holding a value for enabling internal bus cycle inhibition. The value from the register 241 is sent to one of the input terminals of the AND gates 242, 243 and 244. If the register outputs a logic value ‘1’, the particular type of internal bus cycle is inhibited. On the other hand, if the register outputs a logic value ‘0’, inhibition of the particular type of internal bus cycle is disabled so that related internal bus cycle can be observe during error checking.

The AND gates 242, 243 and 244 output an indicator signal representing the internal I/O bus cycle, the internal memory bus cycle and the internal configuration bus cycle respectively. Thereafter, through the OR gate 245 or a combinatorial logic circuit, an inhibiting signal 246 is sent to the bus bridging circuit 210.

According to the aforementioned description, a method of inhibiting bus cycles can be provided for a control chip having a first bus and a second bus. The bus cycle inhibiting method includes the following steps. First, a bus cycle is picked up from the first bus and then the bus cycle is checked to determine if the bus cycle is an internal bus cycle type of the control chip. When the bus cycle is found to be an internal bus cycle type of the control chip, an inhibiting signal is output. Finally, according to the state of the inhibiting signal, the bus cycle is inhibited so that the bus cycle is prevented from re-transmitting to the second bus.

When the bus cycle is determined to be an internal I/O bus cycle, an internal memory bus cycle or an internal configuration bus cycle of the control chip, a corresponding inhibiting signal is issued. In addition, a preset enable value can be used as a reference to output various types of inhibiting signals.

In summary, the invention picks up a bus cycle from a first bus, determines if the bus cycle is an internal bus cycle of the control chip and inhibits the re-transmission of the bus cycle to a second bus on demand. Hence, the second bus will remain idle when an internal bus cycle is received to save electric power. In addition, if the second bus is a PCI bus, the CLKRUN* signal line of a PCI bus may be utilized to trigger any control device coupled to the PCI bus into a sleeping mode of operation to reduce power consumption. With this setup, the battery life of mobile device, such as a notebook, computer is extended.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control chip with a bus cycle inhibiting function for preventing internal bus cycle type of the control chip, picked up from a first bus, from being re-transmitting to a second bus of the control chip, the control chip comprising:
a bus cycle inhibiting circuit for receiving a bus cycle from the first bus and outputting an inhibiting signal once the bus cycle is determined to be an internal bus cycle type of the control chip; and
a bus bridging circuit coupled to the bus cycle inhibiting circuit for inhibiting the re-transmission of the bus cycle on receiving the inhibiting signal.

2. The control chip of claim 1, wherein the bus cycle inhibiting circuit comprises:
a bus resource decode circuit for receiving a bus cycle from the first bus and outputting an indicator signal representing the particular type of bus cycle when the bus cycle is determined to be an internal bus cycle type of the control chip; and
a logic circuit for outputting the inhibiting signal according to a preset enable value and the indicator signal.

3. The control chip of claim 2, wherein the bus resource decode circuit comprises:
an input/output resource decode unit for receiving a bus cycle from the first bus and outputting an indicator signal representing an internal input/output bus cycle when the bus cycle is determined to be an internal input/output bus cycle;
a memory resource decode unit for receiving a bus cycle from the first bus and outputting an indicator signal representing an internal memory bus cycle when the bus cycle is determined to be an internal memory bus cycle; and
a configuration resource decode unit for receiving a bus cycle from the first bus and outputting an indicator signal representing an internal configuration bus cycle when the bus cycle is determined to be an internal configuration bus cycle.

4. The control chip of claim 2, wherein the logic circuit comprises AND gates and OR gates.

5. The control chip of claim 2, wherein the preset enable value is stored inside a register.

6. The control chip of claim 1, wherein the second bus comprises a peripheral component interconnect (PCI) bus.

7. The control chip of claim 1, wherein the control chip comprises a South-bridge control chip.

8. A bus cycle inhibiting circuit for a control chip having at least a first bus and a second bus, comprising:
a bus resource decode circuit for receiving a bus cycle from the first bus and outputting an indicator signal representing the particular type of bus cycle when the bus cycle is determined to be an internal bus cycle; and
a logic circuit for outputting the inhibiting signal according to a preset enable value and the indicator signal.

9. The bus cycle inhibiting circuit of claim 8, wherein the bus resource decode circuit comprises:
an input/output resource decode unit for receiving a bus cycle from the first bus and outputting an indicator signal representing an internal input/output bus cycle when the bus cycle is determined to be an internal input/output bus cycle;
a memory resource decode unit for receiving a bus cycle from the first bus and outputting an indicator signal representing an internal memory bus cycle when the bus cycle is determined to be an internal memory bus cycle; and
a configuration resource decode unit for receiving a bus cycle from the first bus and outputting an indicator signal representing an internal configuration bus cycle when the bus cycle is determined to be an internal configuration bus cycle.

10. The bus cycle inhibiting circuit of claim 8, wherein the logic circuit furthermore comprises AND gates and OR gates.

11. The bus cycle inhibiting circuit of claim 8, wherein the preset enable value is stored inside a register.

12. The bus cycle inhibiting circuit of claim 8, wherein the second bus comprises a peripheral component interconnect (PCI) bus.

13. The bus cycle inhibiting circuit of claim 8, wherein the control chip comprises a South-bridge control chip.

14. A method of inhibiting the bus cycles of a control chip having at least a first bus and a second bus, comprising:
receiving a bus cycle from the first bus and determining if the bus cycle is an internal bus cycle type of the control chip, and outputting an inhibiting signal if the bus cycle is an internal bus cycle type of the control chip; and
inhibiting the re-transmission of the bus cycle to the second bus according to the actual state of the inhibiting signal.

15. The bus cycle inhibiting method of claim 14, wherein the inhibiting signal is issued when the bus cycle is found to be an internal input/output bus cycle, an internal memory bus cycle or an internal configuration bus cycle.

16. The bus cycle inhibiting method of claim 15, wherein a preset enable value is also referenced before issuing the inhibiting signal.

17. The bus cycle inhibiting method of claim 14, wherein the second bus comprises a peripheral component interconnect (PCI) bus.

18. The bus cycle inhibiting method of claim 14, wherein the control chip comprises a South-bridge control chip.
